(19) United States
(12) Patent Application Publication
(10) Pub. No.: US 2023/0250898 A1
(43) Pub. Date: Aug. 10, 2023

(54) U-BOLT MOUNTING DEVICE AND U-BOLT MOUNTING METHOD

(71) Applicant: NIPPON TELEGRAPH AND TELEPHONE CORPORATION, Tokyo (JP)

(72) Inventors: Daiki KOBAYASHI, Tokyo (JP); Yuta IKEGUCHI, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/012,592

(22) PCT Filed: Jun. 26, 2020
(86) PCT No.: PCT/JP2020/025320

§ 371 Date: Dec. 22, 2022

(51) Int. Cl. F16L 3/04; F16L 1/06

(52) U.S. Cl. CPC F16L 3/04; F16L 1/06

(57) ABSTRACT

A U-bolt mounting jig (100) to mount a U-bolt (20) used to fix a pipeline (10) to an installation support member (300) includes a first fitting member (101a) and a second fitting member (101b) that fit over opposite end portions of the U-bolt (20), the opposite end portions being inserted through bolt holes provided on the installation support member (300), and a holding member (102) that holds the first fitting member (101a) and the second fitting member (101b) such that a straight line connecting the opposite end portions is parallel to the installation support member (300).

### TECHNICAL FIELD

The present disclosure relates to a U-bolt mounting jig and a U-bolt mounting method.

### BACKGROUND ART

A U-bolt has been conventionally known as being used to fix a pipeline to an installation support member installed along a structure such as a bridge. For example, Patent Literature 1 discloses a U-bolt structure including a U-bolt used to fix a pipe to a frame, and a saddle including a first support portion that supports the pipe, and a second support portion located between the pipe and the frame, in which the support rigidity and load capacity are improved, and the position of the saddle is finely adjustable. For example, Non-Patent Literature 1 discloses the details about the size of a U-bolt 20.

### CITATION LIST

### Patent Literature

Patent Literature 1: Japanese Patent Laid-Open No. 2016-056812

### Non-Patent Literature

Non-Patent Literature 1: Sudo Manufacturing Co., Ltd. “U-bolt standards and sizes”

### SUMMARY OF THE INVENTION

### Technical Problem

A U-bolt is inserted through bolt holes. The bolt holes are formed to have a larger diameter than that of the U-bolt. For example, as illustrated in FIG. 10A, a bolt hole has a length of 30 mm in the longitudinal direction, and a length of 15 mm in the short-side direction. When a U-bolt with a diameter of 9 mm as illustrated in FIG. 10B is inserted through the bolt hole, then a surplus space is formed in the bolt hole with dimensions of 10.5 mm in its longitudinal direction at opposite ends relative to the U-bolt and 3 mm in its short-side direction at opposite ends relative to the U-bolt.

When tightening nuts onto the U-bolt, a worker usually fastens the nuts one by one. Thus, if the surplus space is formed in the bolt hole, then there is a problem in that a U-bolt 20A is mounted obliquely to an installation support member 300A as illustrated in FIG. 11. There is another problem in that the U-bolt structure disclosed in Patent Literature 1 is made up of a large number of parts, and this leads to an increase in cost and the number of mounting processes, and accordingly makes the maintenance difficult. There is still another problem in that the space between the bridge and the installation support member is so narrow that it is difficult for a worker to fix the pipeline to the installation support member.

The present disclosure has been made in view of the above circumstances, and it is an object of the present disclosure to provide a U-bolt mounting jig and a U-bolt mounting method that enable a U-bolt to be mounted perpendicularly to an installation support member even on a narrow site without increasing the number of parts.

### Means for Solving the Problem

A U-bolt mounting jig according to one embodiment is a U-bolt mounting jig to mount a U-bolt used to fix a pipeline to an installation support member, the U-bolt mounting jig being characterized by including: a first fitting member and a second fitting member that fit over opposite end portions of the U-bolt, the opposite end portions being inserted through bolt holes provided on the installation support member; and a holding member that holds the first fitting member and the second fitting member such that a straight line connecting the opposite end portions is parallel to the installation support member.

A U-bolt mounting method according to another embodiment is a U-bolt mounting method to mount a U-bolt used to fix a pipeline to an installation support member, the U-bolt mounting method being characterized by including: a step of inserting opposite end portions of the U-bolt through bolt holes provided on the installation support member; a step of temporarily tightening nuts onto the U-bolt; a step of mounting a first fitting member and a second fitting member, and a holding member to the U-bolt, the first fitting member and the second fitting member fitting over the opposite end portions, the holding member holding the first fitting member and the second fitting member such that a straight line connecting the opposite end portions is parallel to the installation support member; a step of pulling the holding member toward a direction perpendicular to the installation support member; a step of tightening the nuts onto the U-bolt; and a step of removing the first fitting member, the second fitting member, and the holding member from the installation support member.

### Effects of the Invention

According to the present disclosure, a U-bolt mounting jig and a U-bolt mounting method can be provided, which enable a U-bolt to be mounted perpendicularly to an installation support member even on a narrow site without increasing the number of parts.

### BRIEF DESCRIPTION OF DRAWINGS

FIG. 1 is a side view illustrating an example of the configuration of a U-bolt mounting jig according to a first embodiment.

FIG. 2 is a side view illustrating an example of the configuration of a U-bolt mounting jig according to a second embodiment.

FIG. 3A is a side view illustrating an example of the configuration of a U-bolt mounting jig according to a third embodiment.

FIG. 3B is a plan view illustrating an example of the configuration of the U-bolt mounting jig according to the third embodiment.

FIG. 4 is a side view illustrating an example of the configuration of a U-bolt mounting jig according to a fourth embodiment.

FIG. 5A illustrates an example of a fitting portion in the U-bolt mounting jig according to the fourth embodiment.

FIG. 5B illustrates an example of the fitting portion in the U-bolt mounting jig according to the fourth embodiment.

FIG. 6A illustrates an example of a holding member in the U-bolt mounting jig according to the fourth embodiment.

FIG. 6B illustrates an example of the holding member in the U-bolt mounting jig according to the fourth embodiment.

FIG. 7A illustrates an example of a movable member in the U-bolt mounting jig according to the fourth embodiment.

FIG. 7B illustrates an example of the movable member in the U-bolt mounting jig according to the fourth embodiment.

FIG. 8 is a flowchart illustrating an example of a U-bolt mounting method according to the fourth embodiment.

FIG. 9A illustrates an example of the U-bolt mounting method according to the fourth embodiment.

FIG. 9B illustrates an example of the U-bolt mounting method according to the fourth embodiment.

FIG. 9C illustrates an example of the U-bolt mounting method according to the fourth embodiment.

FIG. 9D illustrates an example of the U-bolt mounting method according to the fourth embodiment.

FIG. 9E illustrates an example of the U-bolt mounting method according to the fourth embodiment.

FIG. 9F illustrates an example of the U-bolt mounting method according to the fourth embodiment.

FIG. 9G illustrates an example of the U-bolt mounting method according to the fourth embodiment.

FIG. 9H illustrates an example of the U-bolt mounting method according to the fourth embodiment.

FIG. 9I illustrates an example of the U-bolt mounting method according to the fourth embodiment.

FIG. 9J illustrates an example of the U-bolt mounting method according to the fourth embodiment.

FIG. 10A is a plan view illustrating an example of a bolt hole.

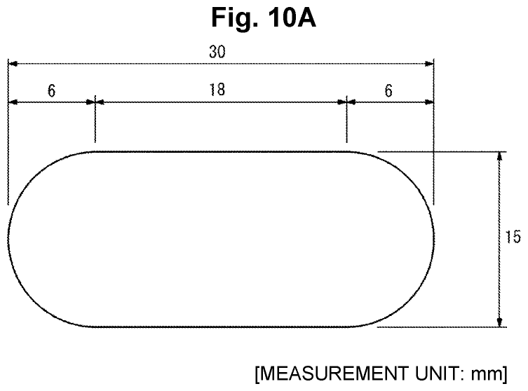

FIG. 10B is a plan view illustrating an example of the relationship between the bolt hole and a diameter of a U-bolt.

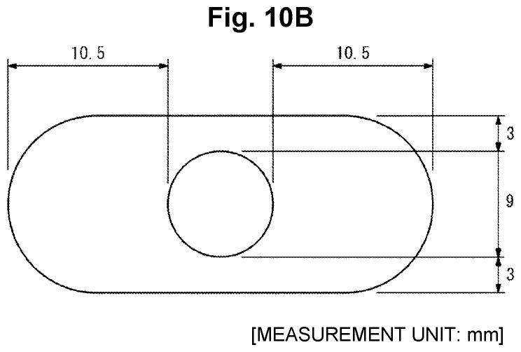

FIG. 11 is a side view illustrating an example of the U-bolt mounted obliquely to an installation support member.

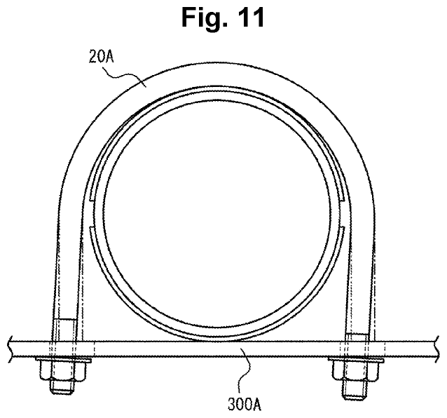

### DESCRIPTION OF EMBODIMENTS

Hereinafter, embodiments for carrying out the present invention will be described with reference to the drawings.

In the specification of the present invention, the wording “the U-bolt is perpendicular to the installation support member” means that the side portions of the U-bolt are located closer to the installation support member relative to the central portion of the U-bolt, and the straight line connecting opposite end portions of the U-bolt is parallel to the surface of the installation support member (at this time, the straight part at each end portion of the U-bolt is perpendicular to the installation support member). The wording “the U-bolt is oblique to the installation support member” means that the straight line connecting opposite end portions of the U-bolt is angled relative to the surface of the installation support member.

In the specification of the present invention, the term “upward direction” means the positive direction parallel to the Z-axis shown in the coordinate axes drawn in the diagrams, while the term “downward direction” means the negative direction parallel to the Z-axis shown in the coordinate axes drawn in the diagrams.

### First Embodiment

Configuration of U-Bolt Mounting Jig

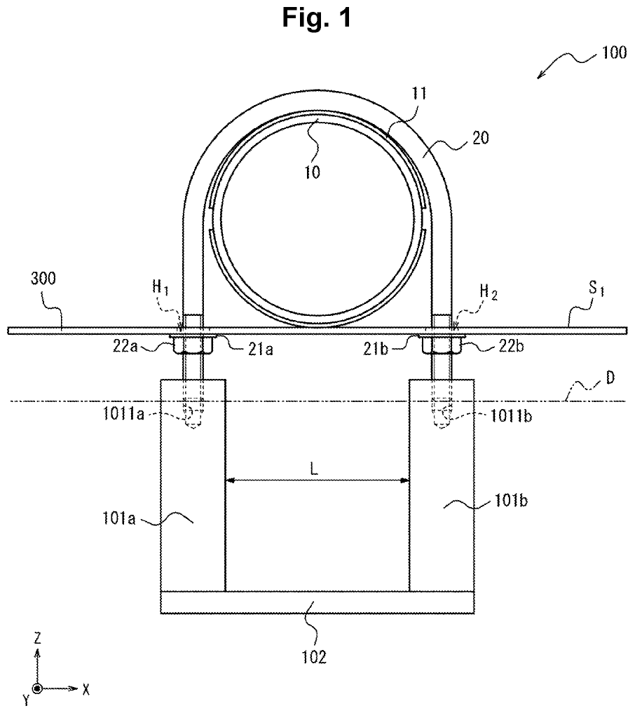

With reference to FIG. 1, the configuration of a U-bolt mounting jig 100 according to a first embodiment is described below.

The U-bolt mounting jig 100 is used to mount a U-bolt 20 to an installation support member 300 installed along a structure such as a bridge. The U-bolt 20 is used to fix a pipeline 10 to the installation support member 300.

It suffices that the installation support member 300 has a configuration in which the installation support member 300 includes a flat surface S1 and is capable of supporting the pipeline 10 in a stable manner. For example, the installation support member 300 is made up of an L-shaped steel material, a flat steel material, or an H-shaped steel material. The installation support member 300 is provided with a bolt hole H1, through which one end portion of the U-bolt 20 is inserted, and a bolt hole H2 through which the other end portion of the U-bolt 20 is inserted.

The pipeline 10 is a pipe made of resin or metal. Examples of the pipeline 10 include a rigid-vinyl pipe, a fiber reinforced plastics (FRP) pipe, a steel pipe, and a fiberglass reinforced plastic mortar (FRPM) pipe. It suffices that the pipeline 10 has a circular cylindrical shape. The configuration of the pipeline 10 is not particularly limited. For example, the pipeline 10 may be provided with joints and may have projections and depressions on the outside. For example, the pipeline 10 may include a protective piece 11 bonded to the outside of the pipeline 10 with an adhesive (see FIG. 1). The pipeline 10 includes the protective piece 11, which enables the pipeline 10 to be protected from the U-bolt 20 when the pipeline 10 is fixed to the installation support member 300 by using the U-bolt 20. Note that FIG. 1 illustrates an example in which a single pipeline 10 is installed on the installation support member 300. However, the number of pipelines 10 to be installed on the installation support member 300 is not particularly limited.

The U-bolt 20 is a piece of steel material including a central portion having a curved shape, side portions having a linear shape, and opposite end portions forming the bolt structure. The opposite end portions of the U-bolt 20 are inserted through the bolt hole H1 and the bolt hole H2 and then screwed into nuts 22a and 22b through the pipeline 10, the installation support member 300, and washers 21a and 21b. The pipeline 10 is thereby fixed to the installation support member 300.

The U-bolt mounting jig 100 includes a fitting member (first fitting member) 101a, a fitting member (second fitting member) 101b, and a holding member 102. The fitting member 101a is provided with a fitting portion 1011a. The fitting member 101b is provided with a fitting portion 1011b.

The fitting members 101a and 101b are provided to be perpendicular to the installation support member 300. The fitting member 101a fits over one end portion of the U-bolt 20 in the fitting portion 1011a. The fitting member 101b fits over the other end portion of the U-bolt 20 in the fitting portion 1011b. A spacing L between the fitting members 101a and 101b is set based on the size of the U-bolt 20 (JIS standards). A worker selects and uses the U-bolt mounting jig 100 appropriately according to the size of the U-bolt 20.

The holding member 102 is provided to be parallel to the installation support member 300. The holding member 102 holds the fitting members 101a and 101b such that the straight line D connecting opposite end portions of the U-bolt 20 is parallel to the installation support member 300. The fitting members 101a and 101b have an equal length in the Z-axis direction, so that the holding member 102 is held parallel to the installation support member 300. Accordingly, the straight line D connecting opposite end portions of the U-bolt 20 can be made parallel to the installation support member 300. The holding member 102 is joined to the fitting member 101a at one end portion of the holding member 102, while being joined to the fitting member 101b at the other end portion. Note that the method to join the holding member 102 to the fitting members 101a and 101b is not limited to a particular joining method. For example, a commonly-known method, such as bolt joining, welding joining, or adhesive joining, is used to join theses members together.

While pulling the holding member 102 toward the downward direction, a worker tightens the nuts 22a and 22b onto the U-bolt 20 through the washers 21a and 21b. This enables the worker to mount the U-bolt 20 perpendicularly to the installation support member 300.

The U-bolt mounting jig 100 according to the first embodiment includes the fitting members 101a and 101b that fit over opposite end portions of the U-bolt 20, and the holding member 102 that holds the fitting members 101a and 101b such that the straight line D connecting the opposite end portions of the U-bolt 20 is parallel to the installation support member 300. A worker uses the U-bolt mounting jig 100 according to the first embodiment, and this enables the worker to mount the U-bolt 20 perpendicularly to the installation support member 300 even on a narrow site without increasing the number of parts.

U-Bolt Mounting Method

Next, the U-bolt mounting method according to the first embodiment is briefly described.

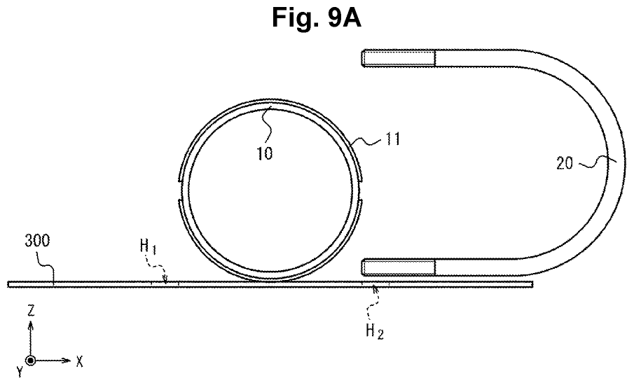

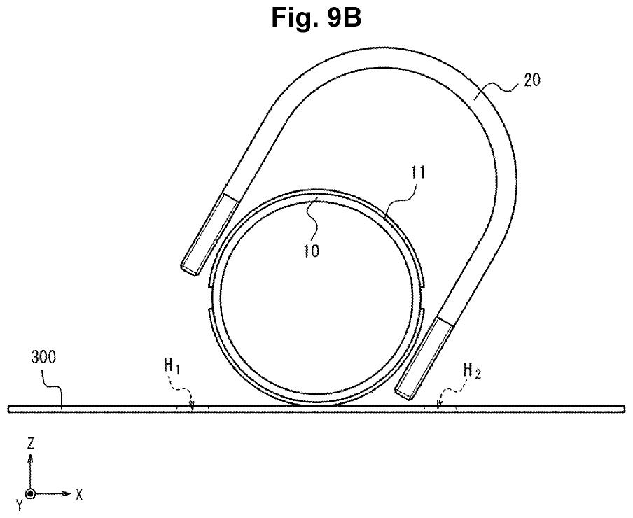

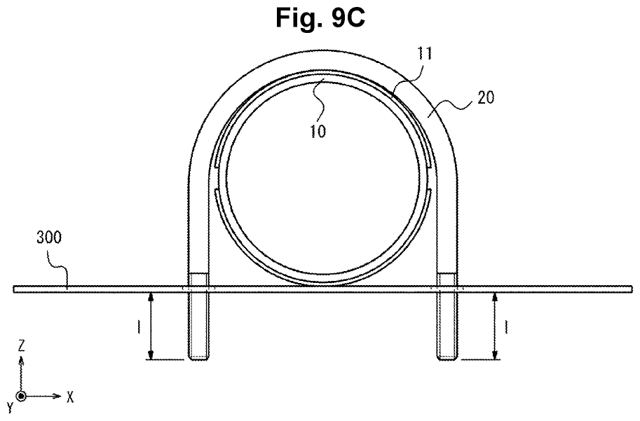

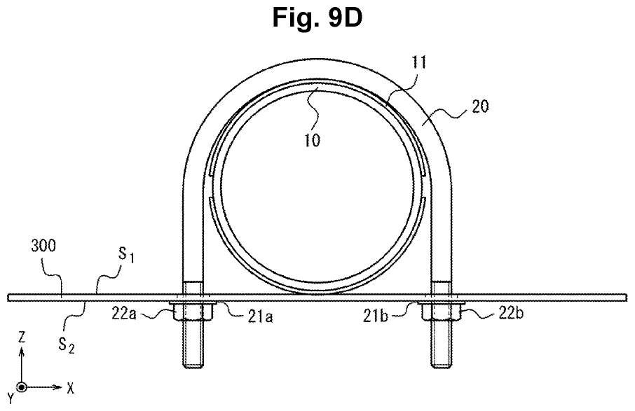

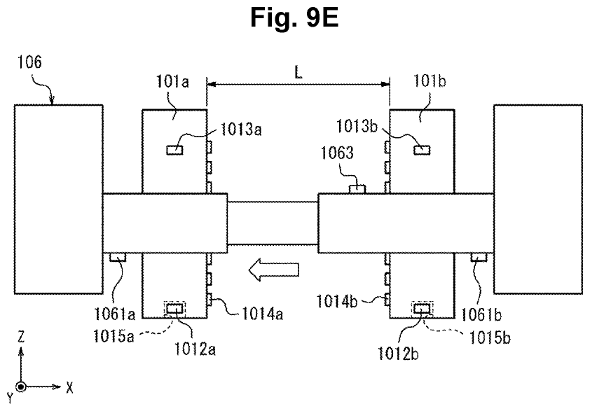

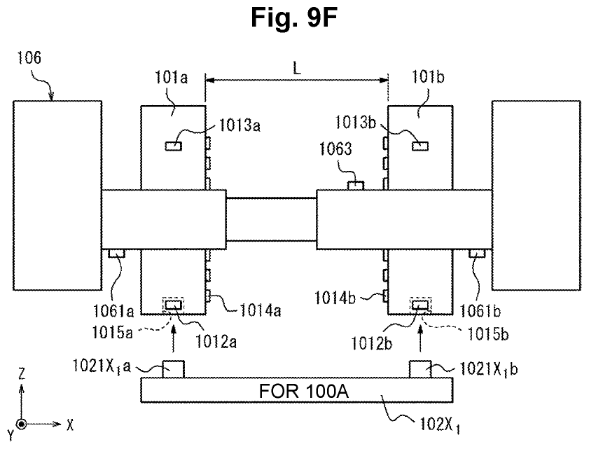

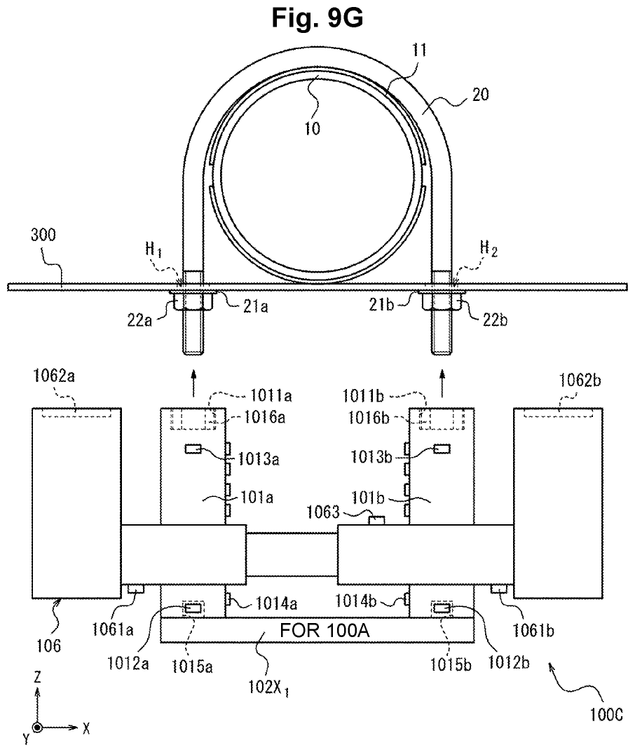

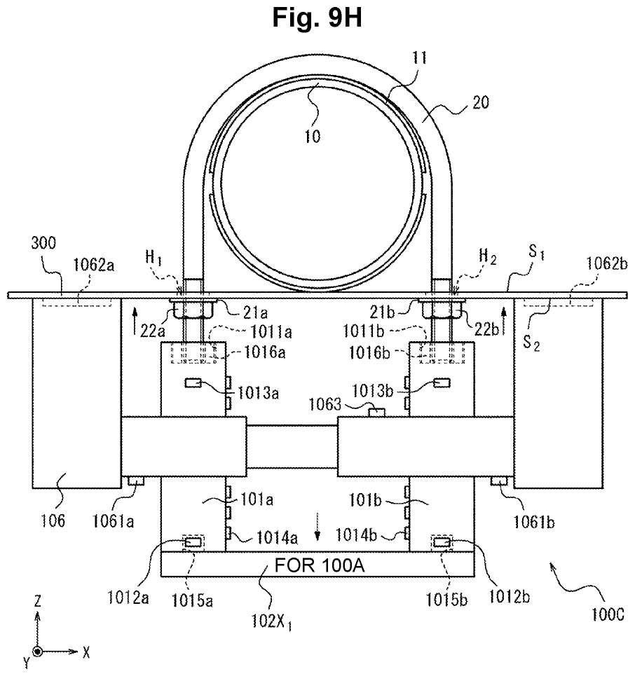

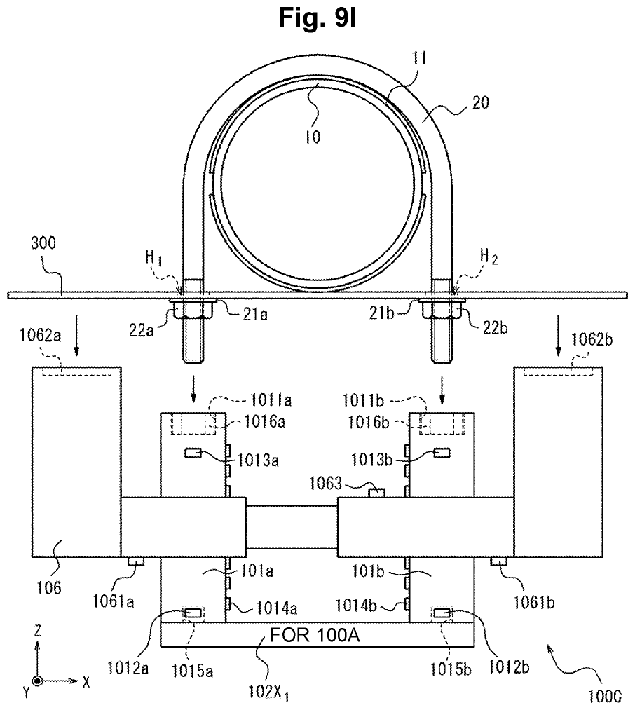

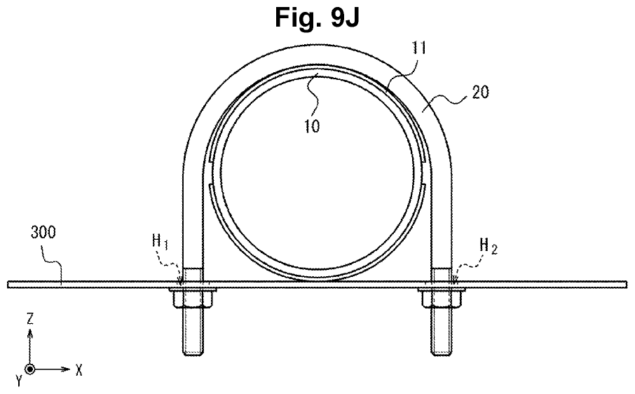

First, a worker places the U-bolt 20 on the installation support member 300 with one side portion of the U-bolt 20 facing the installation support member 300 (see FIG. 9A).

Next, a worker uses the U-bolt 20 to interpose the pipeline 10 between opposite end portions of the U-bolt 20, and then inserts one end portion of the U-bolt 20 through the bolt hole H₁, while inserting the other end portion of the U-bolt 20 through the bolt hole H₂ such that the U-bolt 20 is perpendicular to the installation support member 300 (see FIG. 9B).

Subsequently, a worker adjusts the positions of opposite end portions of the U-bolt 20, such that the screw-thread length I at one end portion of the U-bolt 20 is equal to the screw-thread length I at the other end portion of the U-bolt 20 (see FIG. 9C).

Next, a worker temporarily tightens the nut 22a onto one end portion of the U-bolt 20 through the washer 21a from a surface S₂ of the installation support member 300 on the opposite side to the surface S₁. A worker also temporarily tightens the nut 22b onto the other end portion of the U-bolt 20 through the washer 21b from the surface S₂ of the installation support member 300 on the opposite side to the surface S₁ (see FIG. 9D).

Subsequently, a worker mounts the U-bolt mounting jig 100 according to the first embodiment to the U-bolt 20 (see FIG. 1).

Next, while gripping the holding member 102 and pulling it toward the downward direction, a worker tightens the nut 22a onto one end portion of the U-bolt 20 through the washer 21a from the surface S₂ of the installation support member 300 on the opposite side to the surface S₁, and tightens the nut 22b onto the other end portion of the U-bolt 20 through the washer 21b from the surface S₂ of the installation support member 300 on the opposite side to the surface S₁.

Subsequently, a worker removes the U-bolt mounting jig 100 from the U-bolt 20. Then, the process of mounting the U-bolt 20 ends. With this method, the U-bolt 20 is mounted to the installation support member 300, and the pipeline 10 is fixed to the installation support member 300.

The U-bolt mounting method according to the first embodiment enables the U-bolt 20 to be mounted perpendicularly to the installation support member 300 even on a narrow site without increasing the number of parts.

### Second embodiment

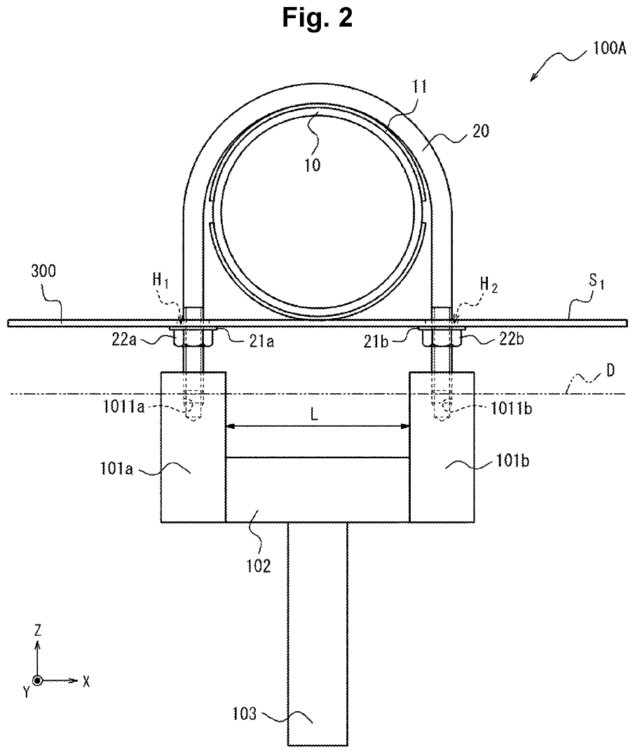

Configuration of U-bolt mounting jig With reference to FIG. 2, the configuration of a U-bolt mounting jig 100A according to a second embodiment is described below.

The U-bolt mounting jig 100A according to the second embodiment is different from the U-bolt mounting jig 100 according to the first embodiment in that the U-bolt mounting jig 100A according to the second embodiment includes a gripping member, while the U-bolt mounting jig 100 according to the first embodiment does not include a gripping member. Note that other configurations are the same as those of the U-bolt mounting jig 100 according to the first embodiment, and therefore redundant descriptions thereof are omitted.

A gripping member 103 is attached to a central portion of the holding member 102. It is preferable for the gripping member 103 to have such a shape that a worker can easily grip by his/her hand. For example, the gripping member 103 is made up of a bar-like member. The gripping member 103 is attached to the central portion of the holding member 102, so that when the gripping member 103 is pulled toward the downward direction by a worker, an equal force can be applied to opposite end portions of the U-bolt 20. Due to this structure, the straight line D connecting opposite end portions of the U-bolt 20 is made parallel to the installation support member 300 easily. This enables a worker to easily mount the U-bolt 20 perpendicularly to the installation support member 300. The gripping member 103 is attached to the central portion of the holding member 102. This also makes it easier for a worker to pull the holding member 102 toward the downward direction, so that the work efficiency in mounting the U-bolt 20 can be improved.

A worker uses the U-bolt mounting jig 100A according to the second embodiment, and this enables the worker to mount the U-bolt 20 perpendicularly to the installation support member 300 even on a narrow site without increasing the number of parts.

U-Bolt Mounting Method

Next, the U-bolt mounting method according to the second embodiment is briefly described.

First, a worker places the U-bolt 20 on the installation support member 300 with one side portion of the U-bolt 20 facing the installation support member 300 (see FIG. 9A).

Next, a worker uses the U-bolt 20 to interpose the pipeline 10 between opposite end portions of the U-bolt 20, and then inserts one end portion of the U-bolt 20 through the bolt hole H₁, while inserting the other end portion of the U-bolt 20 through the bolt hole H₂ such that the U-bolt 20 is perpendicular to the installation support member 300 (see FIG. 9B).

Subsequently, a worker adjusts the positions of opposite end portions of the U-bolt 20, such that the screw-thread length I at one end portion of the U-bolt 20 is equal to the screw-thread length I at the other end portion of the U-bolt 20 (see FIG. 9C).

Next, a worker temporarily tightens the nut 22a onto one end portion of the U-bolt 20 through the washer 21a from the surface S₂ of the installation support member 300 on the opposite side to the surface S₁. A worker also temporarily tightens the nut 22b onto the other end portion of the U-bolt 20 through the washer 21b from the surface S₂ of the installation support member 300 on the opposite side to the surface S₁ (see FIG. 9D).

Subsequently, a worker mounts the U-bolt mounting jig 100A according to the second embodiment to the U-bolt 20 (see FIG. 2).

Next, while gripping the gripping member 103 and pulling it toward the downward direction, a worker tightens the nut 22a onto one end portion of the U-bolt 20 through the washer 21a from the surface S₂ of the installation support member 300 on the opposite side to the surface S₁, and tightens the nut 22b onto the other end portion of the U-bolt 20 through the washer 21b from the surface S₂ of the installation support member 300 on the opposite side to the surface S₁.

Subsequently, a worker removes the U-bolt mounting jig 100A from the U-bolt 20. Then, the process of mounting the U-bolt 20 ends. With this method, the U-bolt 20 is mounted to the installation support member 300, and the pipeline 10 is fixed to the installation support member 300.

The U-bolt mounting method according to the second embodiment enables the U-bolt 20 to be mounted perpendicularly to the installation support member 300 even on a narrow site without increasing the number of parts.

### Third Embodiment

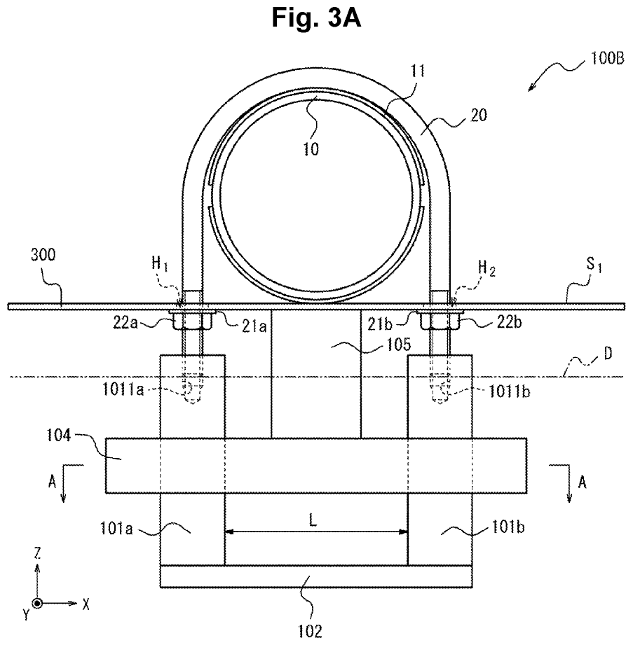

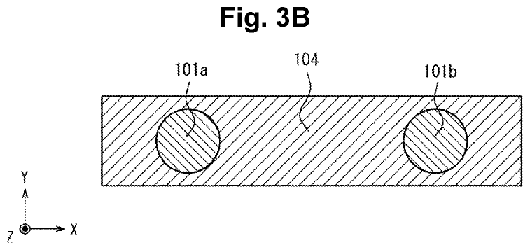

Configuration of U-bolt mounting jig With reference to FIGS. 3A and 3B, the configuration of a U-bolt mounting jig 100B according to a third embodiment is described below.

The U-bolt mounting jig 100B according to the third embodiment is different from the U-bolt mounting jig 100 according to the first embodiment in that the U-bolt mounting jig 100B according to the third embodiment includes a penetration member and a fixed member, while the U-bolt mounting jig 100 according to the first embodiment does not include a penetration member or a fixed member. Note that other configurations are the same as those of the U-bolt mounting jig 100 according to the first embodiment, and therefore redundant descriptions thereof are omitted.

A penetration member 104 is provided to be parallel to the installation support member 300. The penetration member 104 penetrates the fitting members 101a and 101b to be parallel to the installation support member 300 (see FIG. 3B).

A fixed member 105 is joined to the penetration member 104. The fixed member 105 is fixed to the installation support member 300 so as to maintain a constant spacing between the penetration member 104 and the installation support member 300. The fixed member 105 is provided, so that a constant spacing between the penetration member 104 and the installation support member 300 is maintained. Thus, when the holding member 102 is pulled toward the downward direction by a worker, an equal force can be applied to opposite end portions of the U-bolt 20. Due to this structure, the straight line D connecting opposite end portions of the U-bolt 20 is made parallel to the installation support member 300 easily. This enables a worker to easily mount the U-bolt 20 perpendicularly to the installation support member 300.

A worker uses the U-bolt mounting jig 100B according to the third embodiment, and this enables the worker to mount the U-bolt 20 perpendicularly to the installation support member 300 even on a narrow site without increasing the number of parts.

U-Bolt Mounting Method

Next, the U-bolt mounting method according to the third embodiment is briefly described.

First, a worker places the U-bolt 20 on the installation support member 300 with one side portion of the U-bolt 20 facing the installation support member 300 (see FIG. 9A).

Next, a worker uses the U-bolt 20 to interpose the pipeline 10 between opposite end portions of the U-bolt 20, and then inserts one end portion of the U-bolt 20 through the bolt hole H₁, while inserting the other end portion of the U-bolt 20 through the bolt hole H₂ such that the U-bolt 20 is perpendicular to the installation support member 300 (see FIG. 9B).

Subsequently, a worker adjusts the positions of opposite end portions of the U-bolt 20, such that the screw-thread length I at one end portion of the U-bolt 20 is equal to the screw-thread length I at the other end portion of the U-bolt 20 (see FIG. 9C).

Next, a worker temporarily tightens the nut 22a onto one end portion of the U-bolt 20 through the washer 21a from the surface S₂ of the installation support member 300 on the opposite side to the surface S₁. A worker also temporarily tightens the nut 22b onto the other end portion of the U-bolt 20 through the washer 21b from the surface S₂ of the installation support member 300 on the opposite side to the surface S₁ (see FIG. 9D).

Subsequently, a worker mounts the U-bolt mounting jig 100B according to the third embodiment to the U-bolt 20 (see FIG. 3A).

Next, while gripping the holding member 102 and pulling it toward the downward direction, a worker tightens the nut 22a onto one end portion of the U-bolt 20 through the washer 21a from the surface S₂ of the installation support member 300 on the opposite side to the surface S₁, and tightens the nut 22b onto the other end portion of the U-bolt 20 through the washer 21b from the surface S₂ of the installation support member 300 on the opposite side to the surface S₁.

Subsequently, a worker removes the U-bolt mounting jig 100B from the U-bolt 20. Then, the process of mounting the U-bolt 20 ends. With this method, the U-bolt 20 is mounted to the installation support member 300, and the pipeline 10 is fixed to the installation support member 300.

The U-bolt mounting method according to the third embodiment enables the U-bolt 20 to be mounted perpendicularly to the installation support member 300 even on a narrow site without increasing the number of parts.

### Fourth Embodiment

Configuration of U-Bolt Mounting Jig

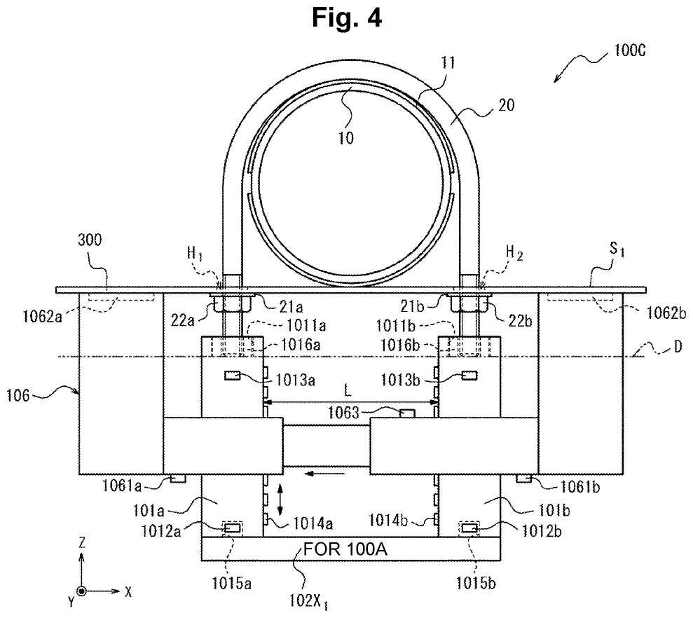

With reference to FIGS. 4 to 7B, the configuration of a U-bolt mounting jig 100C according to a fourth embodiment is described below.

The U-bolt mounting jig 100C includes the fitting members 101a and 101b, a holding member 102X₁, and a movable member 106. The fitting member 101a is provided with the fitting portion 1011a beside the U-bolt 20, while being provided with a recessed portion 1015a beside the holding member 102X₁. The fitting member 101b is provided with the fitting portion 1011b beside the U-bolt 20, while being provided with a recessed portion 1015b beside the holding member 102X₁.

The fitting member 101a includes a button 1012a, a button 1013a, latch mechanisms 1014a, and a rubber member 1016a. The fitting member 101b includes a button 1012b, a button 1013b, latch mechanisms 1014b, and a rubber member 1016b. The holding member 102X₁ includes protruding portions 1021a and 1021b. The movable member 106 includes buttons 1061a and 1061b, mounting portions 1062a and 1062b, and a button 1063.

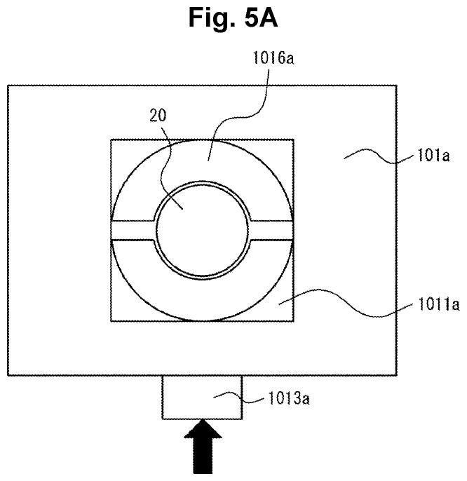

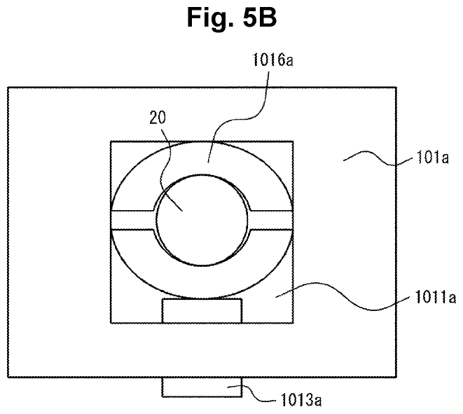

The fitting members 101a and 101b are provided to be perpendicular to the installation support member 300. The fitting member 101a fits over one end portion of the U-bolt 20 in the fitting portion 1011a through the rubber member 1016a. The fitting member 101b fits over the other end portion of the U-bolt 20 in the fitting portion 1011b through the rubber member 1016b. When a worker presses the buttons 1013a and 1013b, the rubber members 1016a and 1016b contract, and then the U-bolt 20 is fixed to the fitting members 101a and 101b (see FIGS. 5A and 5B). It is preferable that the fitting portions 1011a and 1011b are socket fitting portions. This allows the fitting members 101a and 101b to fit over opposite end portions of the U-bolt 20 according to various diameters of the U-bolt 20.

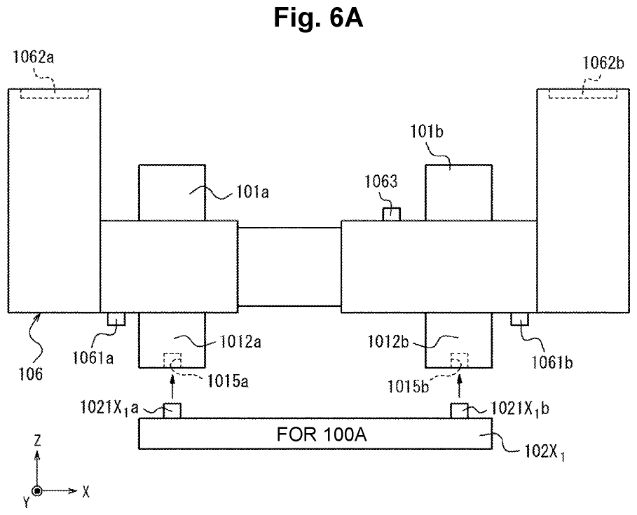

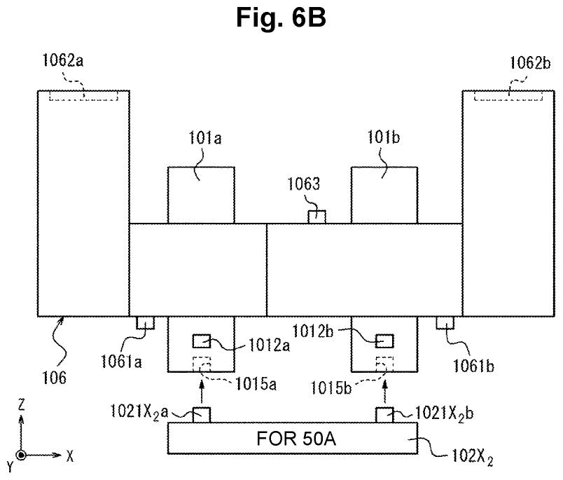

The spacing L between the fitting members 101a and 101b is optionally adjusted by the movable member 106. For example, as illustrated in FIG. 6A, when the spacing between the fitting members 101a and 101b is adjusted appropriately to the holding member 102X₁ for 100A, then, in the fitting member 101a, the recessed portion 1015a is fitted onto the protruding portion 1021X₁a of the holding member 102X₁, and in the fitting member 101b, the recessed portion 1015b is fitted onto the protruding portion 1021X₁b of the holding member 102X₁. For example, as illustrated in FIG. 6B, when the spacing between the fitting members 101a and 101b is adjusted appropriately to a holding member 102X₂ for 50A, then, in the fitting member 101a, the recessed portion 1015a is fitted onto a protruding portion 1021X2a of the holding member 102X₂, and in the fitting member 101b, the recessed portion 1015b is fitted onto a protruding portion 1021X₂b of the holding member 102X₂.

The buttons 1012a and 1012b are used to mount the holding member 102X₁ to the fitting members 101a and 101b. When a worker presses the buttons 1012a and 1012b, the holding member 102X₁ is fixed to the fitting members 101a and 101b. The fitting members 101a and 101b include the buttons 1012a and 1012b, respectively, so that the fitting members 101a and 101b and the holding member 102X₁can be rigidly fixed together. However, the fitting members 101a and 101b do not necessarily include the buttons 1012a and 1012b, respectively.

The buttons 1013a and 1013b are used to mount the U-bolt 20 to the fitting portions 1011a and 1011b. When a worker presses the buttons 1013a and 1013b, the rubber members 1016a and 1016b contract, and thus the U-bolt 20 is fixed to the fitting portions 1011a and 1011b (see FIGS. 5A and 5B). When a worker pulls the buttons 1013a and 1013b, the rubber members 1016a and 1016b expand, and thus the U-bolt 20 is removed from the fitting portions 1011a and 1011b. The fitting members 101a and 101b include the buttons 1013a and 1013b, respectively, so that the fitting members 101a and 101b and the U-bolt 20 can be rigidly fixed together.

The rubber member 1016a is provided in the fitting portion 1011a and positioned between the fitting member 101a and the U-bolt 20. The rubber member 1016b is provided in the fitting portion 1011b and positioned between the fitting member 101b and the U-bolt 20. The rubber member 1016a is positioned between the fitting member 101a and the U-bolt 20, while the rubber member 1016b is positioned between the fitting member 101b and the U-bolt 20, so that the fitting members 101a and 101b and the U-bolt 20 can be rigidly fixed together with high precision.

The latch mechanisms 1014a and 1014b allow the holding member 102X₁ to move in the downward direction when a worker pulls the holding member 102X₁ toward the downward direction. Also, the latch mechanisms 1014a and 1014b fix the holding member 102X₁ in the upward direction when a worker pulls the holding member 102X₁ toward the upward direction. A plurality of latch mechanisms 1014a are provided on the fitting member 101a with a constant spacing therebetween. A plurality of latch mechanisms 1014b are provided on the fitting member 101b with a constant spacing therebetween. The fitting members 101a and 101b include the latch mechanisms 1014a and 1014b, respectively, so that even when a worker releases his/her hands from the holding member 102X₁, the latch mechanisms 1014a and 1014b can still prevent the holding member 102X₁ from moving back in the upward direction. Due to this configuration, a worker can tighten the nuts 22a and 22b onto the U-bolt 20 respectively through the washers 21a and 21b by using his/her hands. This can improve the work efficiency in mounting the U-bolt 20. Note that, after having tightened the nuts 22a and 22b, a worker unlatches the latch mechanisms 1014a and 1014b, and can thereby remove the U-bolt mounting jig 100C from the installation support member 300.

The holding member 102X₁ is provided to be parallel to the installation support member 300. The holding member 102X₁ holds the fitting members 101a and 101b such that the straight line D connecting opposite end portions of the U-bolt 20 is parallel to the installation support member 300. The holding member 102X₁ is joined to the fitting member 101a at one end portion of the holding member 102X₁, while being joined to the fitting member 101b at the other end portion. Note that the method to join the holding member 102X₁ to the fitting members 101a and 101b is not limited to a particular joining method. For example, a commonly-known method, such as bolt joining, welding joining, or adhesive joining, is used to join theses members together.

It is preferable for a worker to select and use a holding member appropriately according to the size of the U-bolt 20. In a case where the nominal dimension of the U-bolt 20 is, for example, 50A, 80A, 100A, or 130A, it is preferable for a worker to appropriately select and use any of a holding member for 50A, a holding member for 80A, a holding member for 100A, or a holding member for 130A. For example, as illustrated in FIG. 6A, in a case where the nominal dimension of the U-bolt 20 is 100A, a worker selects the holding member 102X₁ “for 100A.” For example, as illustrated in FIG. 6B, in a case where the nominal dimension of the U-bolt 20 is 50A, a worker selects the holding member 102X₂ “for 50A.”

It is preferable that the information on the nominal dimension of the U-bolt 20 is written on the holding member at a location where a worker can easily see it (see FIGS. 6A and 6B). For example, it is preferable that the information “for 100A” is written on the holding member 102X₁ “for 100A.” For example, it is preferable that the information “for 50A” is written on the holding member 102X₂ “for 50A.” The information on the nominal dimension of the U-bolt 20 is written on a holding member at a location where a worker can easily see it, so that the worker can easily identify the holding member appropriate to the nominal dimension of the U-bolt 20.

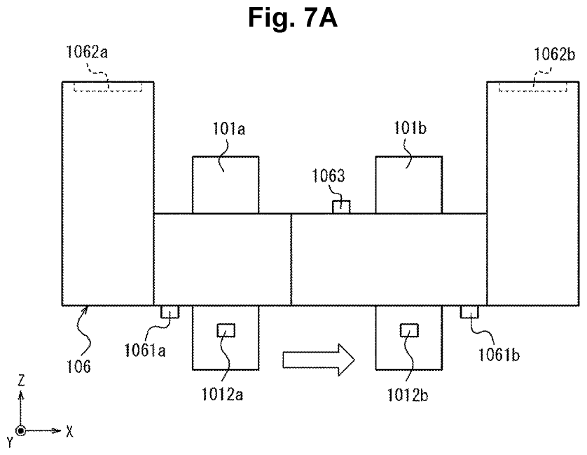

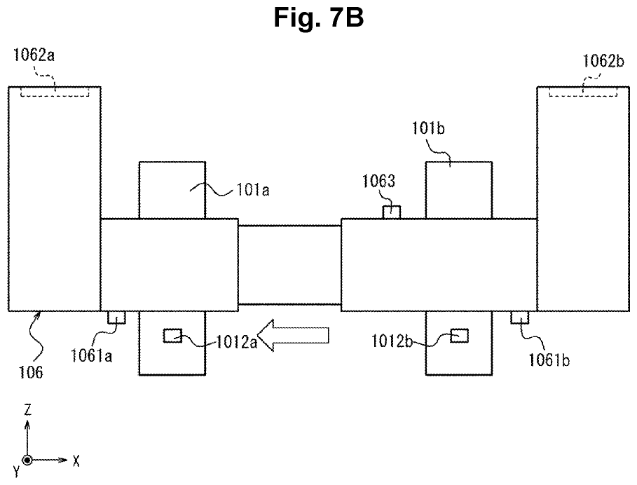

The movable member 106 is mounted to the fitting members 101a and 101b. The movable member 106 slides in a direction parallel to the installation support member 300 (see the arrow in FIGS. 7A and 7B) to adjust the spacing L between the fitting members 101a and 101b. For example, when a worker slides the movable member 106 toward the direction shown by the rightward arrow, the movable member 106 extends, which increases the spacing L between the fitting members 101a and 101b. For example, when a worker slides the movable member 106 toward the direction shown by the leftward arrow, the movable member 106 contracts, which decreases the spacing L between the fitting members 101a and 101b. This enables the spacing L between the fitting members 101a and 101b to be properly adjusted appropriate to the size of the U-bolt 20, the length of the holding member, or other dimension.

For example, as illustrated in FIG. 6A, in a case where the nominal dimension of the U-bolt 20 is 100A, a worker moves the movable member 106 to adjust the spacing L between the fitting members 101a and 101b appropriate to the size of the U-bolt 20 with the nominal dimension of 100A. In this case, the protruding portion 1021X1a of the holding member 102X₁ is fitted into the recessed portion 1015a of the fitting member 101a, while the protruding portion 1021X1b of the holding member 102X₁ is fitted into the recessed portion 1015b of the fitting member 101b. For example, as illustrated in FIG. 6B, in a case where the nominal dimension of the U-bolt 20 is 50A, a worker moves the movable member 106 to adjust the spacing L between the fitting members 101a and 101b appropriate to the size of the U-bolt 20 with the nominal dimension of 50A. In this case, the protruding portion 1021X₂a of the holding member 102X₂ is fitted into the recessed portion 1015a of the fitting member 101a, while the protruding portion 1021X₂b of the holding member 102X₂ is fitted into the recessed portion 1015b of the fitting member 101b. Note that when the U-bolt mounting jig 100C is not used, it is preferable to insert the holding member 102X₂ “for 50A” into the fitting members 101a and 101b.

The buttons 1061a and 1061b are used to fix the fitting members 101a and 101b to the movable member 106. When a worker presses the button 1061a, the fitting member 101a is fixed to the movable member 106. When a worker presses the button 1061b, the fitting member 101b is fixed to the movable member 106. The movable member 106 includes the buttons 1061a and 1061b, so that a worker can move or fix the fitting members 101a and 101b to their proper positions while pulling the holding member 102X₁ toward the downward direction.

The button 1063 is used to fix the movable member 106 to the fitting members 101a and 101b. When a worker presses the button 1063, the movable member 106 is fixed to the fitting members 101a and 101b. The movable member 106 includes the button 1063, so that a worker can optionally slide or fix the movable member 106 in a direction parallel to the installation support member 300.

The mounting portions 1062a and 1062b fix the movable member 106 to the installation support member 300. It is preferable for the mounting portions 1062a and 1062b to be embedded in the movable member 106. The mounting portions 1062a and 1062b may be, for example, a hook or a magnet. However, the configuration of the mounting portions 1062a and 1062b is not particularly limited. The movable member 106 includes the mounting portions 1062a and 1062b, so that the U-bolt mounting jig 100C is fixed to the installation support member 300. Thus, a worker does not need to hold the movable member 106 by his/her hands, or the like. Due to this configuration, a worker can avoid the inconvenience that it is difficult for the worker to work with his/her hands holding the movable member 106. In addition, a worker can tighten the nuts 22a and 22b onto the U-bolt 20 respectively through the washers 21a and 21b by using his/her hands. This can improve the work efficiency in mounting the U-bolt 20.

A worker pulls the holding member 102X₁ toward the downward direction, and accordingly the fitting members 101a and 101b are also pulled toward the downward direction. The movable member 106 is fixed to the installation support member 300, so that a force applied to the fitting portions 1011a and 1011b is balanced with a reaction force at the joined portion of the mounting portion 1062a and the installation support member 300, and at the joined portion of the mounting portion 1062b and the installation support member 300. As a consequence, when the holding member 102X₁ is pulled toward the downward direction by a worker, an equal force can be applied to opposite end portions of the U-bolt 20.

A worker uses the U-bolt mounting jig 100C according to the fourth embodiment, and this enables the worker to mount the U-bolt 20 perpendicularly to the installation support member 300 even on a narrow site without increasing the number of parts.

The U-bolt mounting jig 100C according to the fourth embodiment can properly adjust the spacing between the fitting members 101a and 101b according to the size of the U-bolt. This enables a worker to mount any type of U-bolt perpendicularly to the installation support member 300. Thus, the worker can perform the process of mounting the U-bolt without considering the size of the U-bolt.

U-Bolt Mounting Method

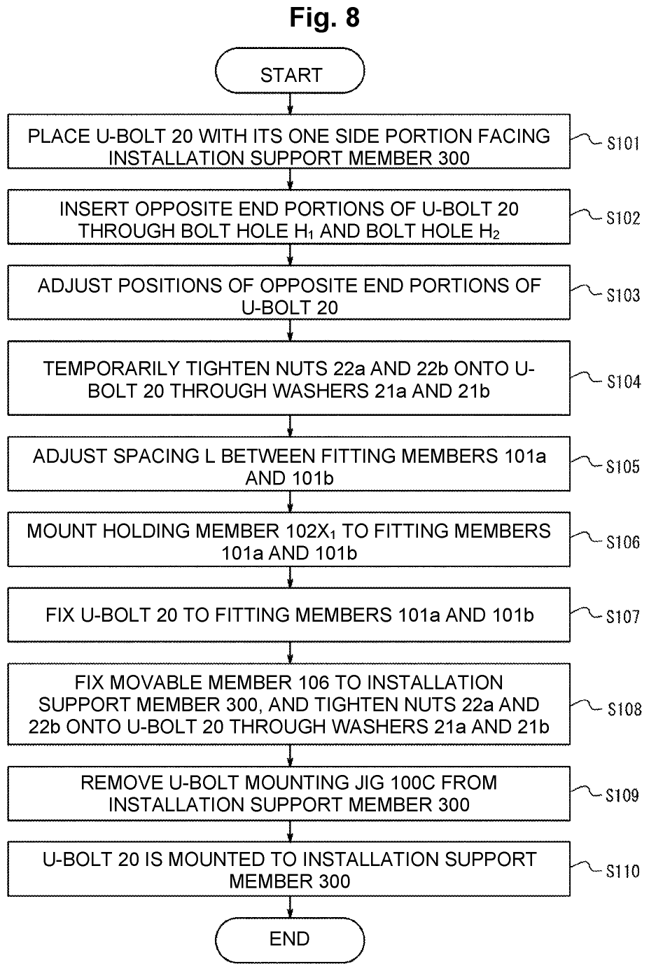

Next, the U-bolt mounting method according to the fourth embodiment is described with reference to FIGS. 8 and 9A to 9J.

In step S101, as illustrated in FIG. 9A, a worker places the U-bolt 20 on the installation support member 300 with one side portion of the U-bolt 20 facing the installation support member 300.

In step S102, as illustrated in FIG. 9B, a worker uses the U-bolt 20 to interpose the pipeline 10 between opposite end portions of the U-bolt 20, and then inserts one end portion of the U-bolt 20 through the bolt hole H₁, while inserting the other end portion of the U-bolt 20 through the bolt hole H₂ such that the U-bolt 20 is perpendicular to the installation support member 300.

In step S103, as illustrated in FIG. 9C, a worker adjusts the positions of opposite end portions of the U-bolt 20, such that the screw-thread length I at one end portion of the U-bolt 20 is equal to the screw-thread length I at the other end portion of the U-bolt 20.

In step S104, as illustrated in FIG. 9D, a worker temporarily tightens the nut 22a onto one end portion of the U-bolt 20 through the washer 21a from the surface S₂ of the installation support member 300 on the opposite side to the surface S₁. A worker also temporarily tightens the nut 22b onto the other end portion of the U-bolt 20 through the washer 21b from the surface S₂ of the installation support member 300 on the opposite side to the surface S₁.

In step S105, as illustrated in FIG. 9E, a worker adjusts the spacing L between the fitting members 101a and 101b by sliding the movable member 106 appropriately to the size of the U-bolt 20, and then presses the button 1063 to fix the movable member 106 to the fitting members 101a and 101b.

In step 5106, as illustrated in FIG. 9F, a worker fits the protruding portion 1021X₁a of the holding member 102X₁ into the recessed portion 1015a of the fitting member 101a, and also fits the protruding portion 1021X₁b of the holding member 102X₁ into the recessed portion 1015b of the fitting member 101b. Then, a worker presses the buttons 1012a and 1012b to mount the holding member 102X₁ to the fitting members 101a and 101b.

In step S107, as illustrated in FIG. 9G, a worker fits the fitting portion 1011a of the fitting member 101a over one end portion of the U-bolt 20, and fits the fitting portion 1011b of the fitting member 101b over the other end portion of the U-bolt 20. Then, a worker presses the buttons 1013a and 1013b to press-fit the U-bolt 20 to the fitting members 101a and 101b to fix the U-bolt 20 thereto.

In step S108, as illustrated in FIG. 9H, a worker fixes the movable member 106 to the installation support member 300 through the mounting portions 1062a and 1062b. Then, a worker grips the holding member 102X₁, pulls it toward the downward direction, and presses the buttons 1061a and 1061b to fix the fitting members 101a and 101b to the movable member 106. With this step, the U-bolt mounting jig 100C is mounted to the installation support member 300.

Then, a worker tightens the nut 22a onto one end portion of the U-bolt 20 through the washer 21a from the surface S₂ of the installation support member 300 on the opposite side to the surface S₁. A worker also tightens the nut 22b onto the other end portion of the U-bolt 20 through the washer 21b from the surface S₂ of the installation support member 300 on the opposite side to the surface S₁.

In step S109, as illustrated in FIG. 9I, a worker removes the U-bolt mounting jig 100C from the installation support member 300.

In step S110, as illustrated in FIG. 9J, a worker ends the process of mounting the U-bolt 20. With this method, the U-bolt 20 is mounted to the installation support member 300, and the pipeline 10 is fixed to the installation support member 300.

The U-bolt mounting method according to the present embodiment includes steps S101 to S110 described above. This enables the U-bolt 20 to be mounted perpendicularly to the installation support member 300 even on a narrow site without increasing the number of parts.

The aforementioned embodiments have been described as typical examples. However, it is apparent to those skilled in the art that many changes and substitutions can be made within the spirit and scope of the present disclosure. Therefore, the present invention should not be construed as being limited by the aforementioned embodiments, and various modifications and changes can be made without departing from the scope of the claims. A plurality of steps described in the flowchart in the embodiment can be combined into a single step, or a single step can be divided into sub-steps.

### REFERENCE SIGNS LIST

10 Pipeline

11 Protective piece

20 U-bolt

21a Washer

21b Washer

22a Nut

22b Nut

100 U-bolt mounting jig

100A U-bolt mounting jig

100B U-bolt mounting jig

100C U-bolt mounting jig

101a Fitting member (first fitting member)

101b Fitting member (second fitting member)

102 Holding member

103 Gripping member

104 Penetration member

105 Fixed member

106 Movable member

300 Installation support member

1011a Fitting portion

1012a Button

1013a Button

1014a Latch mechanism

1015a Recessed portion

1016a Rubber member

1011b Fitting portion

1012b Button

1013b Button

1014b Latch mechanism

1015b Recessed portion

1016b Rubber member

1021a Protruding portion

1021b Protruding portion

1061a Button

1062a Mounting portion

1061b Button

1062b Mounting portion

1063 Button

1. A U-bolt mounting jig for mounting a U-bolt used to fix a pipeline to an installation support member, the U-bolt mounting jig comprising:
a first fitting member and a second fitting member that fit over opposite end portions of the U-bolt, the opposite end portions being inserted through bolt holes provided on the installation support member; and
a holding member that holds the first fitting member and the second fitting member such that a straight line connecting the opposite end portions is parallel to the installation support member, thereby mounting the U-bolt to fix the pipeline to the installation support member.

2. The U-bolt mounting jig according to claim 1, further comprising a gripping member attached to a central portion of the holding member.

3. The U-bolt mounting jig according to claim 1, further comprising:
a penetration member provided to be parallel to the installation support member, the penetration member penetrating the first fitting member and the second fitting member; and
a fixed member joined to the penetration member, and fixed to the installation support member so as to maintain a constant spacing between the installation support member and the penetration member.

4. The U-bolt mounting jig according to claim 1, comprising a movable member that slides in a direction parallel to the installation support member to adjust a spacing between the first fitting member and the second fitting member.

5. A U-bolt mounting method to mount a U-bolt used to fix a pipeline to an installation support member, the U-bolt mounting method comprising:
inserting opposite end portions of the U-bolt through bolt holes provided on the installation support member;
provisionally tightening nuts onto the U-bolt;
mounting a first fitting member and a second fitting member, and a holding member to the U-bolt, the first fitting member and the second fitting member fitting over the opposite end portions, the holding member holding the first fitting member and the second fitting member such that a straight line connecting the opposite end portions is parallel to the installation support member;
pulling the holding member toward a direction perpendicular to the installation support member;
tightening the nuts onto the U-bolt, thereby mounting the U-bolt to fix the pipeline to the installation support member; and
removing the first fitting member, the second fitting member, and the holding member from the installation support member.

6. A U-bolt mounting method to mount a U-bolt used to fix a pipeline to an installation support member, the U-bolt mounting method comprising:
inserting opposite end portions of the U-bolt through bolt holes provided on the installation support member;
temporarily tightening nuts onto the U-bolt;
adjusting a spacing between a first fitting member and a second fitting member by using a movable member, the first fitting member fitting over one end portion of the U-bolt, the second fitting member fitting over the other end portion of the U-bolt, the movable member sliding in a direction parallel to the installation support member;
mounting a holding member to the first fitting member and the second fitting member, the holding member holding the first fitting member and the second fitting member such that a straight line connecting the opposite end portions is parallel to the installation support member;
fixing the movable member to the installation support member;
pulling the holding member toward a direction perpendicular to the installation support member;
tightening the nuts onto the U-bolt, thereby mounting the U-bolt to fix the pipeline to the installation support member; and
removing the first fitting member, the second fitting member, the movable member, and the holding member from the installation support member.

7. The U-bolt mounting jig according to claim 1, wherein the first fitting member includes a fitting portion and a rubber member, and wherein the first fitting member fits over one end portion of the U-bolt in the fitting portion through the rubber member.

8. The U-bolt mounting jig according to claim 7, wherein the first fitting member further includes a button, and wherein, when an operator presses the button, the rubber member contacts at least a part of the one end portion of the U-bolt, thereby fixing the U-bolt to the first fitting member.

9. The U-bolt mounting method according to claim 5, further comprising:
attaching a gripping member to a central portion of the holding member.

10. The U-bolt mounting method according to claim 5, further comprising:
providing a penetration member in parallel to the installation support member, the penetration member penetrating the first fitting member and the second fitting member;
joining a fixed member to the penetration member; and
fixing the fixed member to the installation support member so as to maintain a constant spacing between the installation support member and the penetration member.

11. The U-bolt mounting method according to claim 5, further comprising:
sliding a movable member in a direction parallel to the installation support member to adjust a spacing between the first fitting member and the second fitting member.

12. The U-bolt mounting method according to claim 5, wherein the first fitting member includes a fitting portion and a rubber member, and wherein the first fitting member fits over one end portion of the U-bolt in the fitting portion through the rubber member.

13. The U-bolt mounting method according to claim 12, wherein the first fitting member further includes a button, and wherein, when an operator presses the button, the rubber member contacts at least a part of the one end portion of the U-bolt, thereby fixing the U-bolt to the first fitting member.

14. The U-bolt mounting method according to claim 6, further comprising:
attaching a gripping member to a central portion of the holding member.

15. The U-bolt mounting method according to claim 6, further comprising:
providing a penetration member in parallel to the installation support member, the penetration member penetrating the first fitting member and the second fitting member;
joining a fixed member to the penetration member; and
fixing the fixed member to the installation support member so as to maintain a constant spacing between the installation support member and the penetration member.

16. The U-bolt mounting method according to claim 6, further comprising:
sliding a movable member in a direction parallel to the installation support member to adjust a spacing between the first fitting member and the second fitting member.

17. The U-bolt mounting method according to claim 6, wherein the first fitting member includes a fitting portion and a rubber member, and wherein the first fitting member fits over one end portion of the U-bolt in the fitting portion through the rubber member.

18. The U-bolt mounting method according to claim 17, wherein the first fitting member further includes a button, and wherein, when an operator presses the button, the rubber member contacts at least a part of the one end portion of the U-bolt, thereby fixing the U-bolt to the first fitting member.
